(19) United States
(12) Patent Application Publication
(10) Pub. No.: US 2024/0242159 A1
(43) Pub. Date: Jul. 18, 2024

(54) AUTOMATED ENTERPRISE INFORMATION TECHNOLOGY ALERTING SYSTEM

(71) Applicant: VMWARE, INC., Palo Alto, CA (US)

(72) Inventors: KANNAN PARTHASARATHY, Palo Alto, CA (US); MOHAMMED ABDUL QAVI, Hyderabad (IN)

(21) Appl. No.: 18/127,672

(22) Filed: Mar. 29, 2023

(30) Foreign Application Priority Data
Jan. 17, 2023 (IN) 202341003274

(51) Int. Cl. G06Q 10/0639; G06Q 10/04

(52) U.S. Cl. CPC G06Q 10/06393; G06Q 10/04

(57) ABSTRACT

Disclosed are various examples for automatically analyzing telemetry data from managed devices in one or more organizations and alerting information technology (IT) administrators as early as possible when widespread issues are detected. Telemetry data can be collected from managed devices across multiple organizations and/or enterprises. The collected data can be used to identify events (e.g., system crashes, application crashes, system boot times, system shutdown times, application hangs, application foreground/usage events, device central processing unit (CPU) and memory utilization, battery performance, etc.) that may indicate a potential issue in the IT infrastructure. Time-series data associated with the detected events can be generated and analyzed. Upon detection of a potential issue in view of an analysis of the time-series data, an alert can be generated and presented to an IT administrator or other entity who can further analyze and potentially remedy the issue.

### RELATED APPLICATIONS

Benefit is claimed under 35 U.S.C. 119(a)-(d) to Foreign Application Serial No. 202341003274 filed in India entitled “AUTOMATED ENTERPRISE INFORMATION TECHNOLOGY ALERTING SYSTEM”, on Jan. 17, 2023, by VMware, Inc., which is herein incorporated in its entirety by reference for all purposes.

### BACKGROUND

In an enterprise, an enterprise ecosystem can provide a structure for business processes, information flows, and data security for enterprise employees and the overall enterprise organization. Enterprise information technology (IT) administrators strive to keep downtime of critical services as well as end user devices to a minimum. Downtime of critical services and end user devices can negatively impact employee productivity and ultimately affects business performance metrics. Early detection of IT problems, especially those that affect a large population of users, is therefore very crucial. A common approach in use today is rely on help-desk tickets. When there is an unusually large volume help-desk tickets, support personnel analyze telemetry data collected from end user devices to troubleshoot the problem. The telemetry information can be related to device performance, device health, application performance, application usage, network performance, network health, browser web application usage, browser web application performance, and/or other information. Typically, fine-grained telemetry data is collected continuously from end user devices and sent to a centralized data analytics platform. However, the current approach used by IT administrators to detect and solve issues is reactive and tedious. Furthermore, many end users try to solve problems themselves and do not file help-desk tickets in a timely fashion. As such, some widespread issues might go undetected.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment including a management service that manages user client devices and a data analytics system that collects telemetry data from the managed devices and the management system.

FIG. 2 is a sequence diagram depicting an example operation of the components of the networked environment.

FIGS. 3 and 4 are flowcharts depicting the example operations of a component of the computing environment of the network environment of FIG. 1.

### DETAILED DESCRIPTION

The present disclosure relates to an event alert system that automatically analyzes telemetry data from managed devices in one or more organizations and alerts information technology (IT) administrators as early as possible when widespread issues are detected. According to various embodiments, telemetry data can be collected from managed devices across multiple organizations and/or enterprises. The collected data can be used to identify events (e.g., system crashes, application crashes, system boot times, system shutdown times, application hangs, application foreground/usage events, device central processing unit (CPU) and memory utilization, battery performance, virtual desktop session logon duration times, failed SSO logins, failed application installations, etc.) that may indicate a potential issue in the IT infrastructure associated with one or more organizations and/or enterprises. In various examples, time-series data associated with the detected events can be generated using the crowdsourced data associated with multiple organizations in an enterprise and/or multiple supported enterprises. Upon detection of a potential issue in view of an analysis of the time-series data associated with the events, an alert can be generated and presented to an IT administrator or other entity who can further analyze and potentially remedy the issue.

According to various embodiments, the present disclosure provides an event alert system that identifies potential issues based on an analysis of time-series data while addressing underlying issues with traditional time-series anomaly detection approaches. Time-series anomaly detection is the process for identifying anomalies or outliers in time-series data. For example, the number of system crashes observed over a short time interval (e.g., one hour) can serve as the measurement at each time step, and the goal would be to detect a sudden increase or decrease in the measured value using past historical data as a baseline. One traditional approach for time-series anomaly detection is to build a time-series forecasting model that is trained on historical data and predicts the observation value one time step into the future. The actual observed value can then be compared to the value predicted by the model. If the observed value is close to the predicted value, then it is less likely to be an outlier, whereas if the observed value is far away from the predicted value, it is more likely to be an outlier. An outlier score can be defined based on the difference between the observed value and the predicted value. Note that, with this approach, a separate forecasting model needs to be trained and maintained for each time-series.

This approach suffers from two primary problems. First, when the number of time-series to monitor is large, training and maintaining separate forecasting models adds significantly to the complexity and cost of the overall solution. Second, since a separate forecasting model is built for each time-series, the amount of historical data needed to build robust forecasting models is quite large and impractical in many cases. Therefore, it can be beneficial to provide an event alert system that addresses these issues by combining data received from multiple sources and building a small set of models that are shared across groups of time-series.

According to various examples, the event alert system of the present disclosure can analyze telemetry data that is collected from end user devices managed by a management system associated with one or more organizations or enterprises. In various examples, telemetry data from end user devices managed by the management system can be collected and sent in near real time to a centralized data analytics platform where they are stored in a data lake. In various examples, the end user devices may belong to employees across multiple organizations or enterprises.

In various examples, an aggregation service in the data analytics platform extracts raw event data from the data lake and produces aggregated measurement values associated with events being monitored. In various examples, the monitored events may comprise system crashes, application crashes, system boot times, system shutdown times, application hangs, application foreground/usage events, CPU and memory utilization, battery performance, virtual desktop session logon duration times, failed SSO logins, failed application installations, and/or any other event that may be monitored to detect a problem or otherwise understand the overall health of the IT environment. For example, the aggregation service may compute the number of system crashes within an organization every hour or the number of application crashes for a specific application that occur within a defined time period. The aggregated measurement values can be stored in the data lake in the form of time-series data.

In various examples, the time-series measurements can be placed into groups according to attributes associated with the time-series measurements. The attributes can comprise a system platform, an organization identifier, an application identifier, a geographic location, and/or other type of attribute. For example, all time-series corresponding to system crashes belonging to a given platform (e.g., Windows, Mac OS) may be placed in the same group, regardless of the organization or enterprise associated with the device experiencing the system crash.

According to various examples, the historical aggregated measurement values in the data store can be used to train time-series forecasting models which can be used by the monitoring and alert system to detect potential issues in the IT infrastructure. In various examples, a separate time-series forecasting model is trained for each time-series group. In various examples, historical data from all time-series within a group are used to train the group-level model. Statistical parameters such mean and standard deviation can be computed for the errors on the training and/or validation set. The time-series forecasting models and the error distribution models are stored in a model database.

At periodic intervals (e.g., every hour), the event alert system of the present disclosure can select the appropriate time-series forecasting model from a plurality of time-series forecasting models based at least in part on the timeseries attributes to predict a value for each of the timeseries observations. In various examples, the difference between the observed value and the predicted value can provide the error for each observation. The error value is used to compute the probability of observing the current value given the historical data. Using the probability estimate, the event alert system can generate an outlier score and assign the outlier score to the observation. For example, the outlier score can be 1−p, where p is the probability estimate. In various examples, the event alert system can mark a given observation as an outlier if the outlier score meets or exceeds a predefined threshold. When an observation is marked as an outlier, the event alert system can generate an alert to notify IT administrators of the detected issue. In various examples, the alert can be generated in the form of a user interface, a text message, an email message, push notification, and/or other type of notification.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

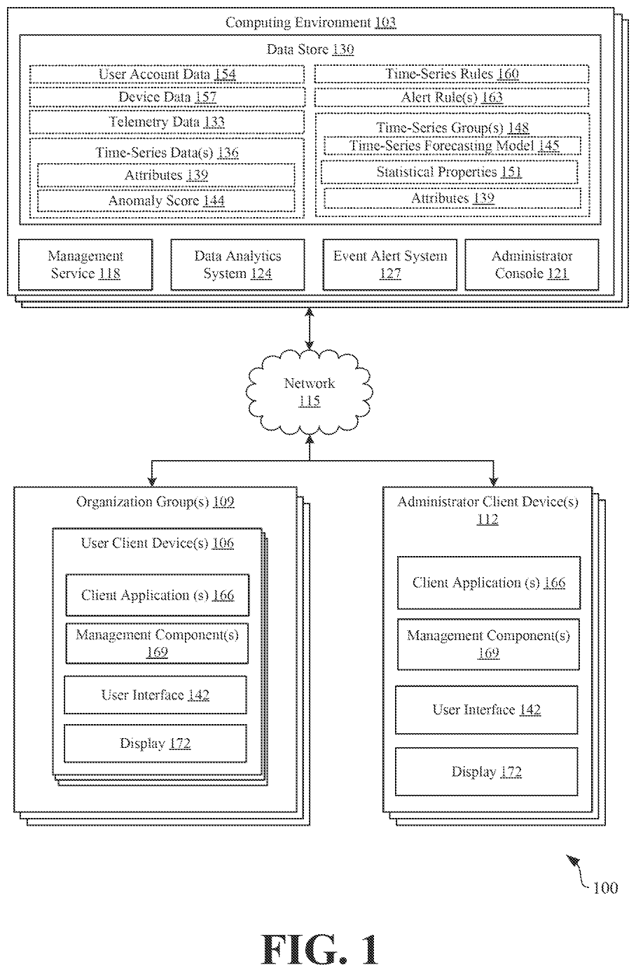

With reference to FIG. 1, shown is an example of a networked environment 100. The networked environment 100 can include a computing environment 103, one or more user client devices 106 (also called client device 106) in one or more organization groups 109, and one or more administrator client devices 112, which are in communication with one another over a network 115. The network 115 can include wide area networks (WANs) and local area networks (LANs). These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 115 can also include a combination of two or more networks 115. Examples of networks 115 can include the Internet, intranets, extranets, virtual private networks (VPNs), and similar networks.

The computing environment 103 can include, for example, a server computer, or any other system providing computing capability. Alternatively, the computing environment 103 can include a plurality of computing devices that are arranged, for example, in one or more server banks, computer banks, or other arrangements. The computing environment 103 can include a grid computing resource or any other distributed computing arrangement. The computing devices can be located in a single installation or can be distributed among many different geographical locations.

The computing environment 103 can also include or be operated as one or more virtualized computer instances. For purposes of convenience, the computing environment 103 is referred to herein in the singular. Even though the computing environment 103 is referred to in the singular, it is understood that a plurality of computing environments 103 can be employed in the various arrangements as described above. As the computing environment 103 communicates with the client device 106 remotely over the network 115, the computing environment 103 can be described as a remote computing environment 103.

Various applications can be executed in the computing environment 103. For example, a management service 118, an administrator console 121, a data analytics system 124, an event alert system 127, as well as other applications, may be executed in the computing environment. Also, various data is stored in a data store 130 that is accessible to the computing environment 103. The data store 130 may be representative of a plurality of data stores 130, which can include relational databases, object-oriented databases, hierarchical databases, hash tables or similar key-value data stores, as well as other data storage applications or data structures. The data stored in the data store 130 is associated with the operation of the various applications or functional entities described below.

The management service 118 can be executed to oversee the operation of user client devices 106 enrolled with the management service 118. In some examples, an enterprise, such as a company, organization, or other entity, can operate the management service 118 to oversee or manage the operation of the user client devices 106 of its employees, contractors, customers, or other users having accounts with the enterprise. An enterprise can include any customer of the management service 118. In various examples, the enterprise can include organization groups 109 that are used to organize users and user client devices 106. For example, a first subset of user client devices 106 may belong to a first organization group 109 and a second subset of user client devices 106 may belong to a second organization group 109. In various examples, an organization group 109 can accommodate functional, geographical, and organization entities within one or more enterprises and enable a multi-tenancy solution such that groups function as independent environments.

The administrator console 121 can provide an administrative interface for configuring the operation of the management service 118 and the configuration of user client devices 106 that are administered by the management service 118. Accordingly, the administrator console 121 can correspond to a web page or web application provided by a web server hosted in the computing environment 103. For example, the administrator console 121 can provide an interface for an administrative user and to create configuration profiles to be applied to individual client devices 106, identify application updates that may be required on individual client devices 106, define recommended applications or updates for individual client devices 106, identify security requirements for individual client devices 106, recommend training that is available for users associated with individual client devices 106, as well as various other actions related to the operation of various implementations.

In addition, the administrator console 121 can provide an interface for an administrative user to define parameters associated with the time-series aggregation (e.g., periods of reviews, group/event attributes 139, etc.) Further, the administrator console 121 can provide an interface for an administrative user to review telemetry data 133 collected from the user client devices 106 by the data analytics system 124 in the computing environment. For example, an administrator interacting with an administrator client device 112 may be able to access reports associated the telemetry data 133 via the administrator console 121 and review the corresponding data 133. In some examples, the administrator console 121 can provide an overview of time-series data 136 for different events and/or different attributes. For example, the administrator may be able to review a history of the number of application crashes of a given application over a period of time. In other examples, the administrator console 121 can provide an interface for an administrator user to receive alerts generated by the event alert system 127 indicating a potential issue in the IT infrastructure based at least in part on an analysis of the collected and crowdsourced telemetry data 133.

The data analytics system 124 can be executed to collect telemetry data 133 associated with the user client devices 106, management service 118, administrator client devices 112, and/or other system that can provide data that can be used to monitor the overall health of an IT infrastructure. In various examples, the data analytics system 124 can receive the telemetry data 133 from one or more of the various devices and/or systems, and store the telemetry data in the data store 130. The data analytics system 124 can perform various operations on the received data such as, for example, validation and enrichment of the events identified in the telemetry data 133 as they are received.

In various examples, the data analytics system 124 can analyze the stored raw telemetry data 133 at periodic intervals (e.g., hourly, daily, weekly, etc.) and generate time-series data 136 that can be used for monitoring and analysis by IT administrators and the event alert system 127. For example, an aggregation service of the data analytics system 124 can run periodically and compute time-series data 136 for a given event for an organization. The time-series data 136 may include, for example, time-series values associated with the number of system crashes in the last hour, the average or median time to boot devices in the last hour, the average or median time to shutdown devices in the last hour, the average or median CPU utilization of all active devices in the last hour, the number of application crashes for each active application in the last hour, the number of application hangs for each active application in the last hour, the number of application foreground events for each active application in the last hour, an average or median logon duration for virtual desktop sessions, a number of failed application installations, a number of failed SSO logins, and/or other measurable event values.

In some examples, the aggregation service of the data analytics system 124 may compute time-series data 136 based at least in part on one or more attributes 139. The attributes 139 can comprise an organization identifier (ID), a device platform, an application ID, the event type (e.g., application crash, application hang, etc.), a geographic location, a store ID, and/or other type of attribute associated with the device and/or event. In various examples, each unique combination of attributes 139 can define a unique time-series for a given time-series data 136. In various examples, data analytics system 124 can store the time-series data 136 and/or other relevant data in the data store 130.

In various examples, the data analytics system 124 can generate a user interface 142 that includes a summary of the time-series data 136 that is stored in the data store 130. In some examples, the data analytics system 124 can render the user interface 142 via the administrator console 121. In other examples, the data analytics system 124 can transmit the user interface 142 and/or user interface data used to generate the user interface 142 to an administrator client device 112 for rendering to allow an IT administrator the ability to review the various time-series data.

The event alert system 127 can be executed to train time-series forecasting models 145, monitor the time-series data 136 generated by the data analytics system 124 using the trained time-series forecasting models 145, and assign an anomaly score 144 to each observation to determine if an alert should be generated and provided to an IT administrator or third-party entity for further review and diagnosis. In various examples, the event alert system 127 can use historical time-series data 136 generated by the data analytics system 124 to train time-series forecasting models 145 for different time-series groups 148 and determine statistical properties 151 for the time-series forecasting models 145. Furthermore, the event alert system 127 can periodically analyze time-series data 136 associated with a predefined period of time to produce a predicted value as well as an anomaly score 144 for the most recent/current observation of each of the time-series being monitored. The event alert system 127 can compare the anomaly score 144 with a threshold value to determine whether an alert should be generated to notify an IT administrator or other entity of a potential issue with the IT infrastructure. In various examples, the event alert system 127 can generate an alert and transmit the alert to the IT administrator or other entity. For example, the event alert system 127 can generate a user interface 142 or user interface code for generating the user interface 142 and transmit the user interface 142 or user interface code to an administrator client device 112. In some examples, the alert can be generated and transmitted to the administrator client device 112 as a push notification. In various examples, the alert can be presented to an administrator or other appropriate entity via the administrator console 121.

Although the management service 118, the data analytics system 124, and the event alert system 127 are illustrated as being separate applications, it should be noted that some or all the functionality of any one of the management service 118, data analytics system 124, and/or the event alert system 127 can be included in the functionality of any one of the management service 118, the data analytics system 124, and/or the event alert system 127.

The data stored in the data store 130 can include, for example, user account data 154, device data 157, telemetry data 133, time-series data 136, time-series rules 160, alert rules 163, time-series groups 148, as well as potentially other data. The user account data 154 can include information pertaining to end users of the client devices 106 enrolled with the management service 118. For instance, the user account data 154 can include data used to authenticate an end user, such as a username, password, email address, biometric data, device identifier, registry identifier, or other data. Additionally, the user account data 154 can include other information associated with an end user, such as name, organization unit, or other information.

The device data 157 can include information about the client device 106. The device data 157 can include, for example, information specifying applications that are installed on the client device 106, configurations or settings that are applied to the client device 106, user accounts associated with the device 106, the physical location of the client device 106, the enterprise associated with the client device 106, the network to which the client device 106 is connected, the device group(s) to which the client device 106 belongs, and/or other information associated with the client device 106.

The telemetry data 133 can include telemetry data collected by the data analytics system 124 from devices and systems included in the overall IT infrastructure. The telemetry data 133 can be collected from the user client devices 106, the administrator client device 112, the management service 118, and/or other devices or services. In various examples, the telemetry data 133 includes data representing events and metrics associated with the devices and/or services included in the IT infrastructure. In various examples, the telemetry data 133 can be related to device performance, device health, application performance, application usage, network performance, network health, browser web application usage, browser web application performance, and/or other information. For example, the telemetry data 133 can include data regarding system crashes, application crashes, system boot times, system shutdown times, application hangs, application foreground/usage events, device central processing unit (CPU) and memory utilization, battery performance, virtual desktop session logon duration times, failed SSO logins, failed application installations, and/or other type of metric or event that may be analyzed to identify a potential issue in the IT infrastructure associated with one or more organizations and/or enterprises.

The time-series data 136 includes data associated with time-series calculated by the data analytics system 124 upon a review and analysis of the collected telemetry data 133. In particular, the time-series data 136 includes aggregated measurement values associated with events that are monitored and included in the telemetry data 133. For example, the data analytics system 124 can run periodically and compute time-series data 136 for a given event. The time-series data 136 may include, for example, time-series values associated with the number of system crashes in the last hour, the average or median time to boot devices in the last hour, the average or median time to shutdown devices in the last hour, the average or median CPU utilization of all active devices in the last hour, the number of application crashes for each active application in the last hour, the number of application hangs for each active application in the last hour, the number of application foreground events for each active application in the last hour, an average or median logon duration for virtual desktop sessions, a number of failed application installations, a number of failed SSO logins, and/or other measurable event values.

In some examples, the time-series data 136 is generated based at least in part on one or more attributes 139. The attributes 139 can comprise an organization identifier (ID), a device platform, an application ID, the event type (e.g., application crash, application hang, etc.), a geographic location, a store ID, and/or other type of attribute associated with the device and/or event. In various examples, each unique combination of attributes 139 can define a unique time-series for a given time-series data 136. In addition, the time-series data 136 can be associated with an anomaly score 144, and/or other data. The anomaly score 144 represents a likelihood and/or presence of an anomaly with respect to an observation within the time-series. The anomaly score 144 is calculated based at least in part on an output (e.g., predicted value) of a time-series forecasting model 145 that is selected for the given time-series and the statistical properties 151 associated with the time-series forecasting model 145. In various examples, the anomaly score 144 can be compared with a predefined threshold to determine whether an alert is to be generated for the given observation in the time-series data 136.

The time-series rules 160 include rules, models, and/or configuration data for the various algorithms or approaches employed by the data analytics system 124 in generating the time-series data 136. In various examples, the time-series rules 160 can include rules and/or configurations for defining the different types of time-series to be calculated, the number of samples required for a calculation, the attributes 139 associated with the given time-series, the periodic cycle for analyzing and generating time-series for the given time-series, and/or other information. In various examples, at least a portion of the time-series rules 160 can be administrator defined and updated via interactions with the administrator console 121 and/or other interface.

The alert rules 163 include rules, models, and/or configuration data for the various algorithms or approaches employed by the event alert system 127 for analyzing the time-series data 136, generating alerts, and/or transmitting alerts to an IT administrator. For example, the alert rules 163 can include rules and configurations defining the periodic cycle for analyzing the time-series data 136. In addition, the alert rules 163 can include one or more thresholds that can be compared with an anomaly score 144 for time-series data 136 in determining whether an alert is to be generated. Further, the alert rules 163 can define how an alert is to be generated and communicated with an IT administrator. For example, an alert can comprise a user interface 142, a push notification, an email, and/or other type of notification component. The type of alert may differ based at least in part on the type of time-series data 136, the level of anomaly (e.g., high outlier, low outlier) that can be based at least in part on difference between anomaly score and threshold value, and/or other factor. In various examples, at least a portion of the time-series rules 160 can be administrator defined and updated via interactions with the administrator console 121 and/or other interface.

In various examples, the time-series data 136 can be assigned a time-series group 148 based at least in part on a set of attributes 139. Each time-series group 148 is associated with its own time-series forecasting model 145. For example, time-series data 136 associated with a first time-series group 148 will be analyzed using the time-series forecasting model 145 that is trained using time-series data 136 with attributes of the first time-series group 148 and time-series data 136 associated with a second time-series group 148 will be analyzed using the time-series forecasting model 145 that is trained using time-series data 136 with attributes of the second time-series group 148. Time-series groups 148 are created to capture common characteristics (e.g., attributes 139) that are shared between individual time-series. For example, all time-series related to application crashes on a specific platform type (e.g., MICROSOFT® Windows, etc.), regardless of the identity of the application or the organization to which a time-series belongs, may be put into a single group and a single model is trained for that time-series group 148. As such, data from multiple disparate sources (e.g., different organizations and applications) are used to train a single time-series forecasting model 145. In this sense, the time-series forecasting model 145 is trained using crowdsourced data. Any event attribute 139 can be used to define the group attributes 135 for a given time-series group 148. For example, if the geographic location of devices 106 is part of event attributes 139, it can be used to define time-series groups 148.

A time-series forecasting model 145 can include, for example, a reinforcement learning algorithm, a logistic regression classifier, a random forest classifier, a decision tree classifier, a XGBoost classifier, a multi-layer perceptron classifier, a recurrent neural network, a feed-forward neural network, a label-specific attention network, and/or any other type of trained model as can be appreciated. In various examples, hyper-parameters of the model can be prespecified in a configuration file, or can be selected automatically using any hyperparameter tuning algorithm such as grid search, random search, and so on.

The statistical properties 151 can include the mean, standard deviation, a histogram of the errors that can be used as an approximation of the probability density function of the errors, and/or other type of statistical property. The statistical properties 151 are based at least in part on the predicted value for each of the instances in the training data set using the trained time-series forecasting models 145. For example, the event alert system 127 can calculate a prediction error by determining the difference between the actual observed value and the predicted value for each training instance. The event alert system 127 can calculate the statistical properties 151 of the prediction error values.

The user client device 106 and the administrator client devices 112 are representative of one or more client devices that may be connected to the network 115. Examples of user client devices 106 and administrator client devices 112 include processor-based systems, such as desktop computers, laptop computers, a personal digital assistant, a cellular telephone, a smartphone, a tablet computer system, smart speakers or similar headless devices, or any other device with like capability. The user client devices 106 and administrator client devices 112 can also be equipped with networking capability or networking interfaces, including a localized networking or communication capability, such as a near-field communication (NFC) capability, radio-frequency identification (RFID) read or write capability, or other localized communication capability.

The user client devices 106 and administrator client devices 112 can each include an operating system which can be configured to execute various client applications 166, such as the management components 169, as well as other applications. In particular, the operating system can include a system software that facilitates operation of the user client device 106 or the administrator client device 112, and execution of additional client applications. The main operating system can include an APPLE® iOS operating system, a MICROSOFT® Windows operating system, an APPLE® macOS operating system, a Linux operating system, a GOOGLE® Android operating system, or other operating systems.

Some client applications 166 can access enterprise data and other network content served up by the computing environment 103 or other servers, thereby rendering a user interface 142 on a display 172, such as a liquid crystal display (LCD), touch-screen display, or other type of display device. To this end, some client applications 166, including the management component 169, can include a browser or a dedicated application, and a user interface 142 can include a network page, an application screen, or other interface. In some examples, a network page can include a web page having source code defined in hypertext markup language (HTML), cascading style sheets (CSS), Javascript, jQuery, or other applicable client-side web-based scripting language. Further, other client applications 166 can include device management applications, enterprise applications, social networking applications, word processors, spreadsheet applications, media viewing applications, instant messaging applications, or other applications.

In various examples, and depending on the permissions of the device 106, 112, the client application 166, including the management component 169, can interact with the management service 118, data analytics system 124, event alert system 127, administrator console 121, or other services in the computing environment 103

The management component 169 can be executed by the client device 106, 112 to maintain data communication with the management service 118 in order to perform various actions on the client device 106, 112 in response to instructions received from the management service 118. In some instances, the management component 169 includes a separate application executing on the client device 106, 112. In other instances, the management component 169 includes a device management framework provided by or included in the operating system installed on the client device 106, 112. The management component 169 can be configured to contact the management service 118 at periodic intervals and request that the management service 118 send any commands or instructions stored in a command queue to the management component 169. The management component 169 can then cause the client device 106, 112 to perform the commands (e.g., provide status request, wipe client device, etc.) provided by the management service 118 or cause the client device 106, 112 to modify the configuration settings installed on the client device 106, 112 in accordance with any updated or received configuration profiles received from the management service 118.

Next, a general description of the operation of the various components of the networked environment 100 is provided. To begin, the management components 169 and/or other client applications 166 can transmit telemetry data 133 over the network to the data analytics system 124. For example, the telemetry data 133 can include data regarding system crashes, application crashes, system boot times, system shutdown times, application hangs, application foreground/usage events, device central processing unit (CPU) and memory utilization, battery performance, virtual desktop session logon duration times, failed SSO logins, failed application installations, and/or other type of metric or event that may be analyzed to identify a potential issue in the IT infrastructure associated with one or more organizations and/or enterprises. In various examples, the telemetry data 133 can further be collected from the management service 118 and/or other services or devices within the computing environment 103. In particular, the telemetry data 133 that is transmitted to the data analytics system 124 includes event and metric data associated with the operation and functionality of the corresponding devices and/or system and is analyzed to monitor the overall health of an IT infrastructure. In various examples, the data analytics system 124 can perform various operations on the received data such as, for example, validation and enrichment of the events identified in the telemetry data 133 as they are received.

In various examples, the data analytics system 124 analyzes the stored raw telemetry data 133 at periodic intervals (e.g., hourly, daily, weekly, etc.) defined by the time-series rules 160 and generates time-series data 136 that can be used for monitoring and analysis by IT administrators and the event alert system 127. For example, an aggregation service of the data analytics system 124 can run periodically and compute time-series data 136 for a given event for an organization. The time-series data 136 may include, for example, time-series values associated with to the number of system crashes in the last hour, the average or median time to boot devices in the last hour, the average or median time to shutdown devices in the last hour, the average or median CPU utilization of all active devices in the last hour, the number of application crashes for each active application in the last hour, the number of application hangs for each active application in the last hour, the number of application foreground events for each active application in the last hour, an average or median logon duration for virtual desktop sessions, a number of failed application installations, a number of failed SSO logins, and/or other measurable event values.

In some examples, the aggregation service of the data analytics system 124 may compute time-series data 136 based at least in part on one or more attributes 139. The attributes 139 can comprise an organization identifier (ID), a device platform, an application ID, the event type (e.g., application crash, application hang, etc.), a geographic location, a store ID, and/or other type of attribute associated with the device and/or event. In various examples, each unique combination of attributes 139 can define a unique time-series for a given time-series data 136. In various examples, data analytics system 124 can store the time-series data 136 and/or other relevant data in the data store 130.

In various examples, the data analytics system 124 can generate a user interface 142 that includes a summary of the time-series data 136 that is stored in the data store 130. In some examples, the data analytics system 124 can render the user interface 142 via the administrator console 121. In other examples, the data analytics system 124 can transmit the user interface 142 and/or user interface data used to generate the user interface 142 to an administrator client device 112 for rendering to allow an IT administrator the ability to review the various time-series data.

In various examples, the event alert system 127 can train time-series forecasting models 145 for different time-series groups 148 using the time-series data 136 generated by the data analytics system 124. To train the time-series forecasting models 145, the event alert system 127 extracts an historical amount of time-series data 136 generated by the data analytics system 124. Each value in the time-series data represents a unique time-series based at least in part on the attributes 139. In various examples, the amount of historical time-series data 136 retrieved from the data store 130 depends on the availability of the time-series data 136, the sampling frequency (e.g., 1 hour), the cycle time-period if the time-series has periodic behavior, and/or other factors. In various examples, the history period covers multiple cycles when the time-series data 136 has periodic behavior.

Once the time-series data 136 is extracted, the event alert system 127 may preprocess the extracted data. For example, the event alert system 127 may filter out “sparse” time-series (e.g., time-series with large number of missing observations) and time-series with low sample counts (e.g., the size of the sample used to compute the observation value is below some predefined threshold). In other examples, the event alert system 127 may impute missing values in the time-series data (e.g., observation values at one or more time steps can be missing in a time-series and they need to be filled in). Other preprocessing steps can also be performed depending on the need.

Once the time-series data is extracted, the event alert system 127 can generate features used to train the time-series forecasting models 145. The exact set of features extracted depends on the type of the time-series forecasting model 145 that is being generated. For example, the set of features described below are suitable for training a regression model that predicts the value of a time-series at the next time step given the values of the time-series in the most recent n time steps (for example, a value of n=168 captures one week of observations when the time step size is one hour).

In various examples, the event alert system 127 can compute scaled lag features, rolling features, time features, and/or any other type of feature that can be used to train a given time-series forecasting model 145.

Scaled Lag Features: At every time step, the values of the time-series in the most recent n time steps are first retrieved—these are referred to as lag values. The n lag values are then linearly scaled so that they are between 0 and 1. Linear scaling can result in a division by zero if the minimum and maximum of the n lag values are the same. To address this issue, scaled lag values are computed as

$${y}_{i} = \frac{( {x}_{i} - {x}_{m i n} )}{( {x}_{m ax} - {x}_{m i n} + ε )} ,$$

where yᵢ is the i^{th} scaled lag value, xᵢ is the i^{th} unscaled lag value, xₘᵢₙ is the minimum of the n unscaled lag values, xₘₐₓ is the maximum of the n unscaled lag values, and ε is a constant close to zero (e.g., ε=0.01).

Rolling Features: These are the mean and standard deviation of the last m scaled lag values. For example, a value of m=4 corresponds to the four most recent time steps. Rolling features can be computed for different values of m. For example, rolling features can be computed for m∈{4, 8, 12, 24}.

Time Features: These are time related features associated with the time step for which a prediction must be made. Examples of time features include time of the day, day of the week, month of the year, and so on.

In various examples, the event alert system 127 can apply additional filters to remove undesirable training data instances. For example, instances that contain too many imputed observations can be removed. In other examples, the event alert system 127 can remove instances with extreme outliers in the unscaled lag values.

The event alert system 127 trains the time-series forecasting models 145 for each group 148 using the calculated features associated with the time-series data 136 belonging to the time-series group 148 to predict the scaled value of time-series observation. Unlike traditional approaches, the event alert system 127 trains separate time-series forecasting models 145 for different time-series groups 148. Time-series groups 148 are created to capture common characteristics (e.g., attributes 139) that are shared between individual time-series. For example, all time-series related to application crashes on a specific platform type (e.g., Windows), regardless of the identity of the application or the organization to which a time-series belongs, may be put into a single group and a single regression model (e.g., time-series forecasting model 145) is trained for that time-series group 148. As such, data from multiple disparate sources (e.g., different organizations/enterprises) are used to train a single time-series forecasting model 145. In this sense, the time-series forecasting model 145 is trained using crowdsourced data. Attributes 139 are used to define given time-series group 148.

In various examples, the event alert system 127 can compute statistical properties 151 based at least in part on the predicted value for each of the instances in the training data set using the trained time-series forecasting models 145. For example, the event alert system 127 can calculate a prediction error by determining the difference between the actual observed value and the predicted value for each training instance. The event alert system 127 can calculate the statistical properties 151 of the prediction error values. The statistical properties 151 can comprise the mean, standard deviation, a histogram of the errors that can be used as an approximation of the probability density function of the errors, and/or other type of statistical property. For each of the time-series forecasting model 145, the event alert system 127 stores the statistical properties 151 associated with the error distribution in the data store 130.

In various examples, the event alert system 127 can train the time-series forecasting models 145 and calculate the statistical properties 151 periodically (e.g., weekly, monthly, etc.). With the time-series forecasting models 145 being trained continually, the problem of model drift that is common in machine learning solutions is automatically addressed.

In various examples, the event alert system 127 can further analyze recently created time-series data 136 using the time-series forecasting models 145 trained using a history of time-series data 136. In contrast to the training discussed above that is executed periodically (e.g., every week), the event alert system 127 can analyze the recently created time-series data 136 at every time step (e.g., every hour). In this stage, the event alert system 127 produces a predicted value as well as an anomaly score 144 for the most recent or current observation of each of the time-series being monitored.

This stage begins with the event alert system 127 extracting the time-series data 136 from the data store 130. However, the amount of time-series data 136 extracted at this stage can differ from the training stage in that the event alert system 127 can extract a smaller history of time-series data 136 than is used for training the models 145. In various examples, the history period depends on a number of most recent time steps n used to generate features that are used to train the time-series forecasting models 145. For example, if features for each training instance are derived from one week of history, the event alert system 127 only needs to obtain one week of history every time it is executed.

Once the time-series data 136 is extracted, the event alert system 127 may preprocess the extracted data. For example, the event alert system 127 may filter out “sparse” time-series (e.g., time-series with large number of missing observations) and time-series with low sample counts (e.g., the size of the sample used to compute the observation value is below some predefined threshold). In other examples, the event alert system 127 may impute missing values in the time-series data (e.g., observation values at one or more time steps can be missing in a time-series and they need to be filled in). Other preprocessing steps can also be performed depending on the need. Once the time-series data is extracted, the event alert system 127 can generate features to use as inputs for the time-series forecasting model 145 associated with the time-series group 148 for the time-series. In various example, the event alert system 127 can store the generated features in the data store 130.

In batch, the event alert system 127 can retrieve the appropriate time-series forecasting model 145 from the data store 130. The time-series forecasting model 145 can be selected based at least in part on the attributes 139 associated with the time-series being evaluated. The selected time-series forecasting model 145 is used to determine the predicted value of each of the time-series at the current time step. For each time-series, the time-series group 148 it belongs to is first determined based on the attributes 139, and the time-series forecasting model 145 corresponding to that group 148 is used for prediction.

In addition to the predicted value, the event alert system 127 computes an anomaly score 144 for the observed value of each time-series. The anomaly score 144 is computed using the statistical properties 151 indicating the error distribution of the associated time-series forecasting model 145. In various examples, the event alert system 127 normalizes the anomaly score 144 between two predefined bounds that indicates how likely it is for the current observation to be an outlier. For example, the anomaly score 144 can be a number between 0 and 1. In this examples, values closer to “0” indicate that the observed value is less likely to be an anomaly, and values closer to “1” indicate that the observed value is more likely to be an anomaly.

In some examples, the event alert system 127 computes the anomaly score 144 using the error distribution and estimating the probability of a random error value exceeding the observed error. For example, the anomaly score can be computed as 1−p, where p is the estimated probability. However, any other method can be used to compute the anomaly score from the estimated probability p. The probability estimation can be made by approximating the error distribution to any well-known distributions such as a Gaussian distribution. The probability estimation can be based on using any other technique. For example, the probability estimation can be made without making any assumptions on the error distribution and using Chebyshev's inequality. Another approach for estimating the probability is to store a histogram of the errors and using that to estimate the probability that an error value will be greater than the observed value.

In various examples, the event alert system 127 categorizes observations for the time-series (e.g., “normal,” “outlier,” etc.) by comparing the anomaly scores 144 against some predefined threshold. For example, an observation with an anomaly score 144 above 0.95 can be categorized as an outlier. In some examples, an outlier can be further categorized into a “high outlier” or “low outlier,” where an outlier is labeled as a high outlier if the observed value is significantly above the predicted value based on a threshold value, and it is labeled as a low outlier if the observed value is significantly below the predicted value based on a threshold value. In addition to the categorization into normal and outlier classes, the upper and lower bounds for predicted values can be computed based on the specific choice of the anomaly score threshold. The anomaly score threshold can be defined in the alert rules 163 and can be single global value that applies to all time-series or can be specified separately for each organization and/or time-series group 148. In various examples, IT administrators can define the score thresholds via the administrator console 121 or other user interface 142 that interfaces with the data analytics system 124 and/or the event alert system 127.

In various examples, when an outlier is detected the event alert system 127 can generate an alert and transmit the alert to an IT administrator or other appropriate entity. For example, the event alert system 127 can generate an alert as a user interface 142 that is presented to the user via the administrator console 121 and/or other interface between the administrator client device 112 and the event alert system 127 and/or the data analytics system 124. In addition, to alerts being generated and presented to IT administrators via the administrator console 121, the alerts can be generated and sent to IT administrators as soon as they are detected using push notifications, email, and/or other type of notification mechanism.

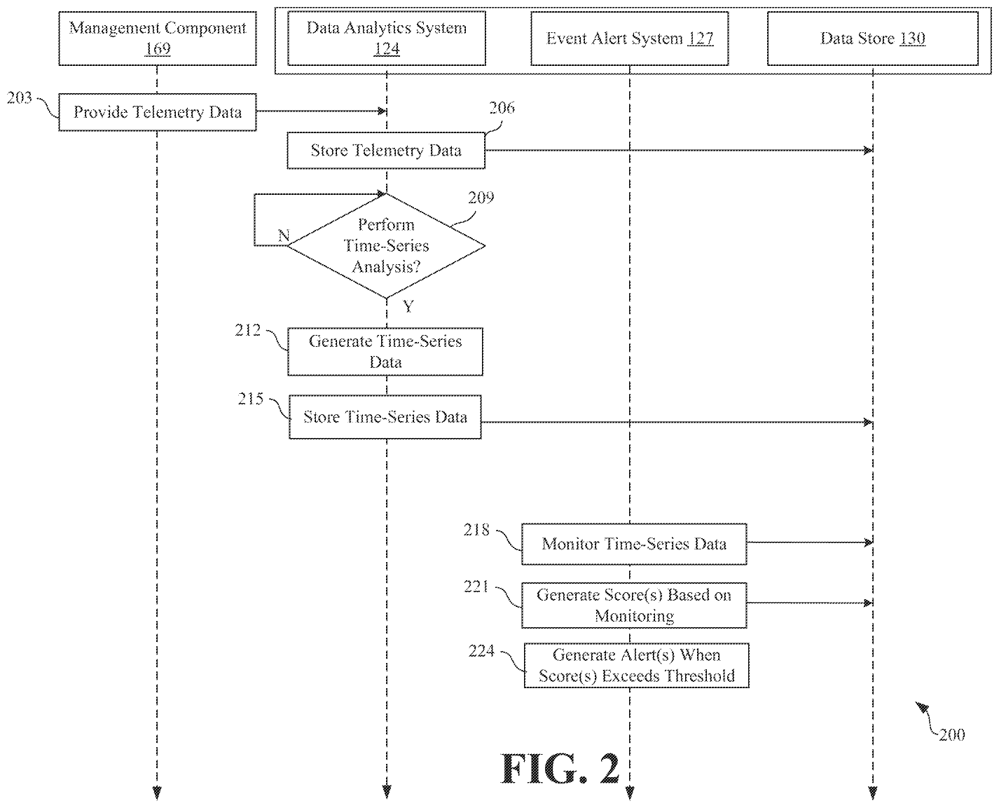

Moving on to FIG. 2, shown is a sequence diagram 200 depicting the interactions between the various components of the network environment 100 according to various embodiments of the present disclosure. The sequence diagram 200 of FIG. 2 is intended to illustrate how the event alert system 127 determines whether an alert should be generated to indicate a potential issue within the IT infrastructure by using time-series data 136 generated by the data analytics system 124 using telemetry data 133 collected from client devices 106, 112. As an alternative, the sequence diagram 200 of FIG. 2 can be viewed as depicting an example of elements of a method implemented within the network environment 100.

Beginning at step 203, the management components 169 executing on the client devices 106, 112 within one or more organizations or enterprises can provide telemetry data to the data analytics system 124 of the computing environment 103. In various examples, the telemetry data 133 includes data representing events and metrics associated with the devices and/or services included in the IT infrastructure. For example, the telemetry data 133 can include data regarding system crashes, application crashes, system boot times, system shutdown times, application hangs, application foreground/usage events, device central processing unit (CPU) and memory utilization, battery performance, virtual desktop session logon duration times, failed SSO logins, failed application installations, and/or other type of metric or event that may analyzed to identify a potential issue in the IT infrastructure associated with one or more organizations and/or enterprises. Although illustrated as receiving the telemetry data 133 via the management component 169 of a client device 106, 112, the data analytics system 124 collect telemetry data 133 associated with the user client devices 106, management service 118, administrator client devices 112, and/or other system that can provide data that can be used to monitor the overall health of an IT infrastructure.

At step 206, the data analytics system 124 stores the received telemetry data 133 in the data store 130. In various examples, prior to storing the telemetry data 133, the data analytics system 124 can perform various operations on the received data such as, for example, validation and enrichment of the events identified in the telemetry data 133 as they are received.

At step 209, the data analytics system 124 determines whether time-series data 136 analysis is to be performed. For example, the data analytics system 124 can generate time-series data 136 periodically based on a time-series indicator. For example, if the time-series data 136 corresponds to events that occur hourly, the data analytics system 124 may generate time-series data 136 from the collected telemetry data 133 on an hourly basis. The period time can be defined by the time-series rules 160. If the time-series data 136 is to be generated, the data analytics system 124 proceeds to step 212. Otherwise, the data analytics system 124 waits until it is time to generate the time-series data 136.

At step 212, the data analytics system 124 generates the time-series data 136. In particular, the data analytics system 124 obtains the telemetry data 133 from the data store 130. In various examples, the data analytics system 124 computes time-series data 136 for a given event for an organization. The time-series data 136 may include, for example, time-series values associated with to the number of system crashes in a given period, the average or median time to boot devices in a given period, the average or median time to shutdown devices in a given period, the average or median CPU utilization of all active devices in a given period, the number of application crashes for each active application in a given period, the number of application hangs for each active application in a given period, the number of application foreground events for each active application in a given period, an average or median logon duration for virtual desktop sessions, a number of failed application installations, a number of failed SSO logins, and/or other measurable event values. In some examples, the aggregation service of the data analytics system 124 may compute time-series data 136 based at least in part on one or more attributes 139. In various examples, each unique combination of attributes 139 can define a unique time-series for a given time-series data 136. At step 215, the data analytics system 124 stores the time-series data 136 and/or other relevant data in the data store 130.

At step 218, the event alert system 127 monitors the generated time-series data 136. In various examples, the event alert system 127 monitors or otherwise analyzes recently created time-series data 136 using the time-series forecasting models 145 trained using a history of time-series data 136. In contrast to the training of the model 145 which is executed periodically (e.g., every week), the event alert system 127 can analyze the recently created time-series data 136 with higher frequency and at every time step (e.g., every hour).

In various examples, the event alert system 127 extracts or otherwise obtains the time-series data 136 from the data store 130. The amount of time-series data 136 extracted can be based at least in part on a number of most recent time steps n used to generate features that are used to train the time-series forecasting models 145. For example, if features for each training instance are derived from one week of history, the event alert system 127 only needs to obtain one week of history every time it is executed.

Once the time-series data 136 is obtained, the event alert system 127 may preprocess the data and generate features to use as inputs for the time-series forecasting model 145 associated with the time-series group 148 for the time-series. The event alert system 127 can retrieve the appropriate time-series forecasting model 145 from the data store 130. The time-series forecasting model 145 can be selected based at least in part on the attributes 139 associated with the time-series being evaluated. The selected time-series forecasting model 145 is used to determine the predicted value of each of the time-series at the current time step. For each time-series, the time-series group 148 it belongs to is first determined based on the attributes 139, and the time-series forecasting model 145 corresponding to that group 148 is used for prediction.

At step 221, the event alert system 127 generates an anomaly score 144 based at least in part on the output of the time-series forecasting model 145 (e.g., predicted value), the observed value, and the statistical properties 151 indicating the error distribution of the associated time-series forecasting model 145. In various examples, the event alert system 127 normalizes the anomaly score 144 between two predefined bounds that indicates how likely it is for the current observation to be an outlier. For example, the anomaly score 144 can be a number between 0 and 1. In this examples, values closer to “0” indicate that the observed value is less likely to be an anomaly, and values closer to “1” indicate that the observed value is more likely to be an anomaly.

At step 224, the event alert system 127 compares the anomaly score 144 with a predefined threshold and generates an alert when the anomaly score 144 meets or exceeds the predefined threshold. In response to the anomaly score 144 meeting or exceeding the predefined threshold, the event alert system 127 can generate an alert and transmit the alert to the IT administrator or other entity. For example, the event alert system 127 can generate a user interface 142 or user interface code for generated the user interface 142 and transmit the user interface 142 or user interface code to an administrator client device 112. In some examples, the alert can be generated and transmitted to the administrator client device 112 as a push notification. In various examples, the alert can be presented to an administrator or other appropriate entity via the administrator console 121. Thereafter, this portion of the process proceeds to completion.

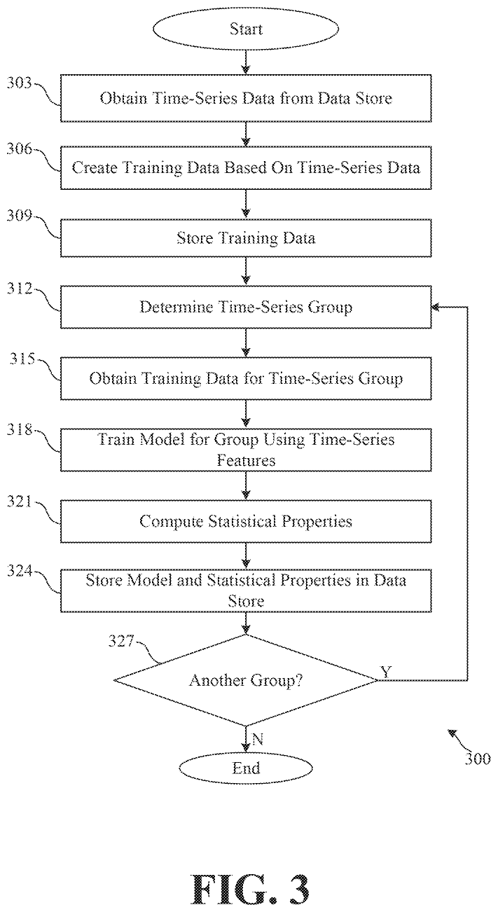

Moving on to FIG. 3, shown is a flowchart 300 that provides one example of the operation of a portion of the event alert system 127. The flowchart of FIG. 3 can be viewed as depicting an example of elements of a method implemented by the event alert system 127 executing in the computing environment 103 according to one or more examples. The separation or segmentation of functionality as discussed herein is presented for illustrative purposes only.

Beginning at step 303, the event alert system 127 obtains time-series data 136 from the data store 130. In various examples, the event alert system 127 extracts an historical amount of time-series data 136 generated by the data analytics system 124. Each value in the time-series data represents a unique time-series based at least in part on the event attributes 139. In various examples, the amount of historical time-series data 136 retrieved from the data store 130 depends on the availability of the time-series data 136, the sampling frequency (e.g., 1 hour), the cycle time-period if the time-series has periodic behavior, and/or other factors. In various examples, the history period covers multiple cycles when the time-series data 136 has periodic behavior.

At step 306, the event alert system 127 creates training data based at least in part on the time-series data 136 that is extracted. In particular, the event alert system 127 may preprocess the extracted data and generate features used to train the time-series forecasting models 145. The exact set of features extracted depends on the type of the time-series forecasting model 145 is being generated. For example, the set of features described below are suitable for training a regression model that predicts the value of a time-series at the next time step given the values of the time-series in the most recent n time steps (for example, a value of n=168 captures one week of observations when the time step size is one hour). In various examples, the event alert system 127 can compute scaled lag features, rolling features, time features, and/or any other type of feature that can be used to train a given time-series forecasting model 145. In various example, the event alert system 127 can apply additional filters to remove undesirable training data instances. For example, instances that contain too many imputed observations can be removed. In other examples, the event alert system 127 can remove instances with extreme outliers in the unscaled lag values. At step 309, the event alert system 127 stores the training data.

At step 312, the event alert system 127 determines a time-series group 148 associated with a given time-series forecasting model 145 to be trained. Time-series groups 148 are created to capture common characteristics (e.g., group attributes 139) that are shared between individual time-series within a group 148. For example, all time-series related to application crashes on a specific platform type (e.g., Windows), regardless of the identity of the application or the organization to which a time-series belongs, may be put into a single group for training a time-series forecasting model 145 for that time-series group 148. The time-series group 148 can be determined based at least in part on a set of attributes 139. In some examples, the time-series groups 148 are defined by an administrator and/or other entity.

At step 315, the event alert system 127 obtains the training data for the time-series group 148 from the data store 130. In particular, the event alert system 127 obtains the training data that was generated for time-series that are associated with the attributes 139 that define the time-series group 148.

At step 318, the event alert system 127 trains the time-series forecasting model 145 using the obtained training data that corresponds to multiple time-series that are all associated with the time-series group 148. As such, data from multiple disparate sources (e.g., different organizations and applications) are used to train a single time-series forecasting model 145. In various examples, the time-series forecasting model 145 can include, for example, a reinforcement learning algorithm, a logistic regression classifier, a random forest classifier, a decision tree classifier, a XGBoost classifier, a multi-layer perceptron classifier, a recurrent neural network, a feed-forward neural network, a label-specific attention network, and/or any other type of model 145 as can be appreciated. In various examples, hyper-parameters of the model can be prespecified in a configuration file, or can be selected automatically using any hyperparameter tuning algorithm such as grid search, random search, and so on.

At step 321, the event alert system 127 computes statistical properties 151 based at least in part on the predicted value for each of the instances in the training data set using the trained time-series forecasting model 145. For example, the event alert system 127 can calculate a prediction error by determining the difference between the actual observed value and the predicted value for each training instance. The event alert system 127 can calculate the statistical properties 151 of the prediction error values. The statistical properties 151 can comprise the mean, standard deviation, a histogram of the errors that can be used as an approximation of the probability density function of the errors, and/or other type of statistical property. At step 324, the event alert system 127 stores the statistical properties 151 associated with the error distribution and the trained time-series forecasting model 145 for the given time-series group 148 in the data store 130.

At step 327, the event alert system 127 determines if there is another time-series group 148 for training a time-series forecasting model 145. If there is another time-series group 148, the event alert system 127 returns to step 312. Otherwise, the process ends.

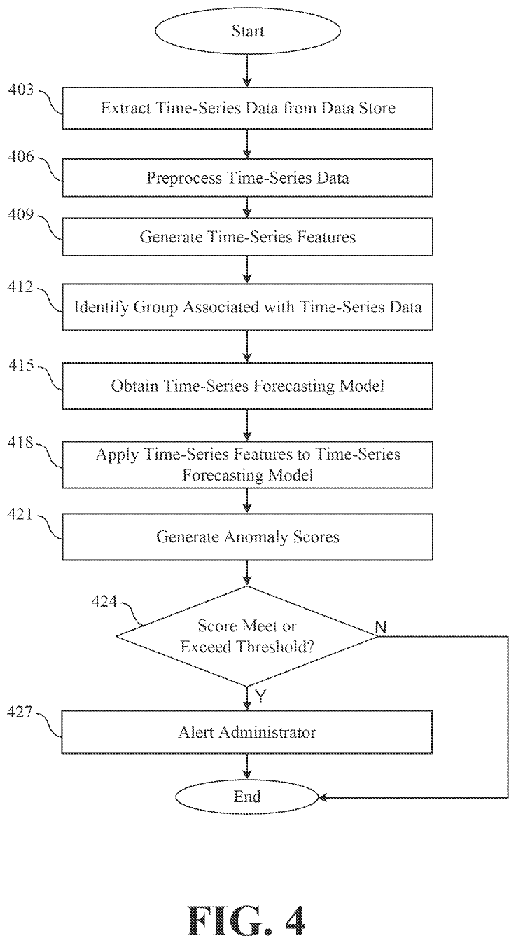

Moving on to FIG. 4, shown is a flowchart 400 that provides one example of the operation of a portion of the event alert system 127. The flowchart of FIG. 4 can be viewed as depicting an example of elements of a method implemented by the event alert system 127 executing in the computing environment 103 according to one or more examples. The separation or segmentation of functionality as discussed herein is presented for illustrative purposes only.

Beginning at step 403, the event alert system 127 obtains time-series data 136 from the data store 130. The amount of time-series data 136 extracted can be based at least in part on a number of most recent time steps n used to generate features that are used to train the time-series forecasting models 145. For example, if features for each training instance are derived from one week of history, the event alert system 127 only needs to obtain one week of history every time it is executed.

At step 406, the event alert system 127 preprocesses the extracted data. For example, the event alert system 127 may filter out “sparse” time-series (e.g., time-series with large number of missing observations) and time-series with low sample counts (e.g., the size of the sample used to compute the observation value is below some predefined threshold). In other examples, the event alert system 127 may impute missing values in the time-series data (e.g., observation values at one or more time steps can be missing in a time-series and they need to be filled in). Other preprocessing steps can also be performed depending on the need.

At step 409, the event alert system 127 generates features to use as inputs for the time-series forecasting model 145 associated with the time-series group 148 for the time-series. The exact set of features depends on the type of the time-series forecasting model 145 that is trained. For example, the set of features for a regression model that predicts the value of a time-series at the next time step given the values of the time-series in the most recent n time steps can include scaled lag features, rolling features, time features, and/or any other type of feature.

At step 412, the event alert system 127 determines a time-series group 148 associated with the obtained time-series data 136. The time-series group 148 can be based at least in part on the attributes 139 associated with the time-series data 136. For example, the attributes 139 can comprise an organization identifier (ID), a device platform, an application ID, the event type (e.g., application crash, application hang, etc.), a geographic location, a store ID, and/or other type of attribute associated with the device and/or event. Time-series groups 148 are created to capture common characteristics (e.g., attributes 139) that are shared between individual time-series.

At step 415, the event alert system 127 obtains the time-series forecasting model 145 from the data store 130 that is associated with the time-series group 148 in which the time-series being evaluated belongs. In particular, the time-series forecasting model 145 can be stored in the data store 130 according to the time-series group 148 and/or the corresponding attributes 139. At step 418, the event alert system 127 applies the time-series features to the time-series forecasting model 145 to obtain the predicted value.

At step 421, the event alert system 127 generates one or more anomaly scores 144 based at least in part on the output of the time-series forecasting model 145 (e.g., predicted value), the observed value, and the statistical properties 151 indicating the error distribution of the associated time-series forecasting model 145. In various examples, the event alert system 127 normalizes the anomaly score 144 between two predefined bounds that indicates how likely it is for the current observation to be an outlier. For example, the anomaly score 144 can be a number between 0 and 1. In this examples, values closer to “0” indicate that the observed value is less likely to be an anomaly, and values closer to “1” indicate that the observed value is more likely to be an anomaly.

At step 424, the event alert system 127 compares the anomaly score 144 with a predefined threshold to determine if the anomaly score 144 meets or exceeds the predefined threshold. If the anomaly score 144 fails to meet or exceed the predefined threshold value, this process proceeds to completion. If the anomaly score 144 meets or exceeds the predefined threshold, the event alert system 127 proceeds to step 427.

At step 427, the event alert system 127 generates an alert and transmits the alert to the IT administrator or other entity. For example, the event alert system 127 can generate a user interface 142 or user interface code for generating the user interface 142 and transmit the user interface 142 or user interface code to an administrator client device 112. In some examples, the alert can be generated and transmitted to the administrator client device 112 as a push notification. In various examples, the alert can be presented to an administrator or other appropriate entity via the administrator console 121. Thereafter, this portion of the process proceeds to completion.

The client devices 106, 112 or devices comprising the computing environment 103 can include at least one processor circuit, for example, having a processor and at least one memory device, both of which are coupled to a local interface, respectively. The device can include, for example, at least one computer, a mobile device, smartphone, computing device, or like device. The local interface can include, for example, a data bus with an accompanying address/control bus or other bus structure.

Stored in the memory device are both data and several components that are executable by the processor. In particular, stored in the one or more memory devices and executable by the device processor of the client device 106, 112 can be the client application 166, the management component 169, and potentially other applications. Also stored in the memory can be a data store and other data.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

The client devices 106, 112 can include a display 172 upon which a user interface 142 generated by the administrator console 121, the client application 166, the management component 169, the management service 118, the data analytics system 124, the event alert system 127, or another application can be rendered. In some examples, the user interface 142 can be generated using user interface data provided by the computing environment 103. The client device 106, 112 can also include one or more input/output devices that can include, for example, a capacitive touchscreen or other type of touch input device, fingerprint reader, or keyboard.

Although the management service 118, administrator console 121, the data analytics system 124, the event alert system 127, the client application 166, the management component 169, and other various systems described herein can be embodied in software or code executed by general-purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The sequence diagram of FIG. 2 and the flowcharts of FIGS. 3 and 4 show examples of the functionality and operation of an implementation of portions of components described herein. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or other system. The machine code can be converted from the source code. If embodied in hardware, each block can represent a circuit or a number of interconnected circuits to implement the specified logical function(s).

Although the sequence diagram of FIG. 2 and the flowcharts of FIGS. 3 and 4 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some examples, one or more of the blocks shown in the drawings can be skipped or omitted.

Also, any logic or application described herein that includes software or code can be embodied in any non-transitory computer-readable medium for use by or in connection with an instruction execution system such as, for example, a processor in a computer system or other system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

It is emphasized that the above-described examples of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure.

What is claimed is:

1. A system, comprising:
a computing device comprising a processor and a memory; and
machine-readable instructions stored in the memory which, when executed by the processor, cause the computing device to at least:
obtain time-series data associated with a number of occurrences of a type of event across a plurality of client devices within a plurality of organizations over a predefined period of time;
select a particular time-series forecasting model from a plurality of time-series forecasting models based at least in part on a plurality of attributes associated with the plurality of client devices and the type of event;
apply the time-series data to the particular time-series forecasting model;
generate a score based at least in part on an output of the particular time-series forecasting model; and
generate an alert in an instance in which the score meets or exceeds a predefined threshold.

2. The system of claim 1, wherein the type of event comprises at least one of a system crash, an application crash, a device boot time, a device shutdown time, an application hang, an application foreground event, battery utilization, device central processing unit (CPU) utilization, device memory utilization, a virtual desktop session logon duration time, a failed SSO login, or a failed application installation.

3. The system of claim 1, wherein individual time-series forecasting models of the plurality of time-series forecasting models are associated with a respective time-series group of a plurality of time-series groups, individual time-series groups of the plurality of series groups being defined according to the plurality of attributes.

4. The system of claim 3, wherein the time-series forecasting model is trained using historical time-series data that is included in a same time-series group of the plurality of time-series groups.

5. The system of claim 1, wherein the plurality of attributes comprise at least one of: a system platform, an organization identifier, an application identifier, or a geographic location.

6. The system of claim 1, wherein, when executed by the processor, the machine readable instructions further cause the computing device to at least, send the alert to an administrator client device via a push notification.

7. The system of claim 1, wherein generating the alert comprises generating a user interface comprising an indication of an anomaly associated with an observation in the time-series data and when executed by the processor, the machine-readable instructions further cause the computing device to at least send the user interface to an administrator client device.

8. A non-transitory computer-readable medium embodying executable instructions which, when executed by a computing device, cause the computing device to at least:
obtain time-series data associated with a number of occurrences of a type of event across a plurality of client devices within a plurality of organizations over a predefined period of time;
select a particular time-series forecasting model from a plurality of time-series forecasting models based at least in part on a plurality of attributes associated with the plurality of client devices and the type of event;
apply the time-series data to the particular time-series forecasting model;
generate a score based at least in part on an output of the particular time-series forecasting model; and
generate an alert in an instance in which the score meets or exceeds a predefined threshold.

9. The non-transitory computer-readable medium of claim 8, wherein the type of event comprises at least one of a system crash, an application crash, a device boot time, a device shutdown time, an application hang, an application foreground event, battery utilization, device central processing unit (CPU) utilization, device memory utilization, a virtual desktop session logon duration time, a failed SSO login, or a failed application installation.

10. The non-transitory computer-readable medium of claim 8, wherein individual time-series forecasting models of the plurality of time-series forecasting models are associated with a respective time-series group of a plurality of time-series groups, individual time-series groups of the plurality of series groups being defined according to the plurality of attributes.

11. The non-transitory computer-readable medium of claim 10, wherein the time-series forecasting model is trained using historical time-series data that is included in a same time-series group of the plurality of time-series groups.

12. The non-transitory computer-readable medium of claim 8, wherein the plurality of attributes comprise at least one of: a system platform, an organization identifier, an application identifier, or a geographic location.

13. The non-transitory computer-readable medium of claim 8, wherein, when executed by the computing device, the executable instructions further cause the computing device to at least, send the alert to an administrator client device via a push notification.

14. The non-transitory computer-readable medium of claim 8, wherein generating the alert comprises generating a user interface comprising an indication of an anomaly associated with an observation in the time-series data and when executed by the computing device, the executable instructions further cause the computing device to at least send the user interface to an administrator client device.

15. A computer-implemented method, comprising:
obtaining, via at least one computing device, time-series data associated with a number of occurrences of a type of event across a plurality of client devices within a plurality of organizations over a predefined period of time;
selecting, via the at least one computing device, a particular time-series forecasting model from a plurality of time-series forecasting models based at least in part on a plurality of attributes associated with the plurality of client devices and the type of event;
applying, via the at least one computing device, the time-series data to the particular time-series forecasting model;
generating, via the at least one computing device, a score based at least in part on an output of the particular time-series forecasting model; and
generating, via the at least one computing device, an alert in an instance in which the score meets or exceeds a predefined threshold.

16. The computer-implemented method of claim 15, wherein the type of event comprises at least one of a system crash, an application crash, a device boot time, a device shutdown time, an application hang, an application foreground event, battery utilization, device central processing unit (CPU) utilization, device memory utilization, a virtual desktop session logon duration time, a failed SSO login, or a failed application installation.

17. The computer-implemented method of claim 15, wherein individual time-series forecasting models of the plurality of time-series forecasting models are associated with a respective time-series group of a plurality of time-series groups, individual time-series groups of the plurality of series groups being defined according to the plurality of attributes.

18. The computer-implemented method of claim 17, wherein the time-series forecasting model is trained using historical time-series data that is included in a same time-series group of the plurality of time-series groups.

19. The computer-implemented method of claim 15, wherein the plurality of attributes comprise at least one of: a system platform, an organization identifier, an application identifier, or a geographic location.

20. The computer-implemented method of claim 15, wherein generating the alert comprises generating a user interface comprising an indication of an anomaly associated with an observation in the time-series data and further comprising sending the user interface to an administrator client device.
